(19) United States
(12) Patent Application Publication
(10) Pub. No.: US 2012/0052171 A1
(43) Pub. Date: Mar. 1, 2012

(54) HIGH POWERED, SINGLE SERVE, AUTOMATIC DRIP BREWED BEVERAGE MAKER AND RELATED SCOOP

(76) Inventors: William D Starr, Richmond, VA (US); Mark C. Steiner, Midlothian, VA (US); Seth A. Lichtman, Glen Allen, VA (US); Paula L. Pennington, Mechanicsville, VA (US); Atle Larsen, Henrico, VA (US); Michael H. Garman, Midlothian, VA (US)

(21) Appl. No.: 13/211,939

(22) Filed: Aug. 17, 2011

Related U.S. Application Data
(60) Provisional application No. 61/379,118, filed on Sep. 1, 2010.

(51) Int. Cl. A47J 31/00; A23F 5/26

(52) U.S. Cl. 426/431; 99/295

(57) ABSTRACT

An unpressurized, relatively high powered beverage maker and related scoop for producing a single serving of brewed beverage, such as coffee, may include a showerhead with a preferential water outlet, a overflow port in the sidewall of the scoop, a secondary filter, and the like. The beverage maker is a drip (gravity) beverage maker with a relatively high water flow rate due to use of a relatively high powered water heater. The brewing happens at atmospheric pressure.

This application claims the benefit of U.S. provisional application No. 61/379,118, filed Sep. 1, 2010.

### FIELD OF THE DISCLOSURE

The present disclosure is directed to a high powered, single serve, automatic drip brewed beverage maker and scoop for use therewith. While a typical single serve automatic drip brewed beverage maker operates with approximately a 600 watt heater and a multi-serve automatic drip brewed beverage maker might typically use a 900 watt heater, the single serve brewed beverage maker disclosed herein is intended for use with a 1000+ watt heater. A high flow rate is thereby achieved yet the beverage maker disclosed herein is an unpressurized (drip) beverage maker that can accommodate finely ground infusible material, such as fine ground coffee. Accordingly, the subject single serve brewed beverage maker provides a new construction and new features to account for the relatively high water flow from the heater through an unpressurized brew chamber including, among other features, a scoop with a overflow port, a secondary filter below the scoop, and a showerhead with preferential water distribution port.

### BACKGROUND

Brewed beverage makers, such as coffeemakers, have become common kitchen appliances for almost every home. In an automatic drip coffeemaker (ADC), a user first fills a fresh water reservoir. Before or after the step of filling the fresh water reservoir, the user transfers coffee grounds from a storage container into a filtered brew basket to be placed in the brewed beverage maker. The user then initiates a brew cycle. In response, the beverage maker heats the water that then flows through a showerhead to drip onto the infusible material in the brew basket. Often times, coffee grounds are spilled during the transfer of the infusible material from the container to the brew basket. This can be frustrating to a user and also difficult to clean.

In addition to spillage during the preparation process, it is also possible to spill used coffee grounds from the filter basket after a brew cycle. There is a need for a coffeemaker that simplifies the brew cycle preparation and cleaning processes.

Multi-serve brewed beverage makers struggle to make acceptable tasting beverages in low volume portions. A multi-serve beverage maker is specifically sized and configured to fill a large beverage receptacle such as a carafe. Creating a low volume (single serving) necessitates starting the brew cycle with a low volume of water. The coffee bed in the brew basket is very thin. As there is not much coffee in the brew basket, the water burrows through the coffee bed and does not steep for the appropriate amount of time. Moreover, the heater does not get the water fully up to temperature during the relatively short brew cycle. As a result, when brewing a low volume portion in a regular (multi-serve) beverage maker, the resulting beverage is weak and/or cold in comparison to a typical brewed beverage from a multi-serve beverage maker.

Multi-serve coffeemakers do such a poor job that dedicated single serve coffeemakers are increasingly popular. Many single serve brewed beverage makers use a pressurized system whereby the brew basket is a sealed container and the water is pumped from the fresh water reservoir to the brew chamber under pressure, such as by an air or fluid pump. Pressurization allows for a high flow rate. The brew basket or cartridge is sealed in a manner that prevents spilling from the brew basket and maintains a pressurized space. Among other drawbacks, the pump, controls and the like for creating a pressurized brewing system increase the complexity and cost of the beverage maker.

These pressurized single serve makers often limit a consumer's choices and raise the consumers costs. Pressurized single serve makers use pre-packaged coffee cartridges or pods. As such, the amount of coffee in the cartridge or pod is fixed. Therefore, the user cannot control the strength of the coffee. If the user wants to make a larger volume of coffee, the beverage is accordingly diluted and vice versa. The user would be required to use multiple pods/cartridges to create stronger coffee, particularly when filling a larger receptacle like a travel mug. Accordingly, the user has to run multiple brew cycles to fill a travel mug, which negates the perceived speed and efficacy of a pressurized single serve system. Moreover, these pre-packaged cartridges and pods are expensive compared to loose coffee grinds that can be bought in bulk. Each brew cycle costs the user more money than if they were using loose coffee grinds. If multiple cartridges are required for larger volume, the cost goes up even more.

It is not environmentally friendly to have to dispose of prepackaged cartridges or pods after each brew cycle. The pods or cartridges are full of infusible material and cannot generally be recycled. Finally, a user may not be able to find their favorite brands of roasted coffee in the pre-packaged pod or cartridge that works with their particular pressurized system. Users would likely appreciate a cheaper beverage maker that can perform in the manner of a more complex and costly pressurized system. It is thought that they might want to pay less for each cup of coffee that their beverage maker produces while having the freedom to select the coffee roaster of their choice.

Existing non-pressurized single serve ADCs are considered to have relatively slow brew cycles, which may frustrate a user that wants the convenience (real or perceived) and more instant gratification of a pressurized single serve brewing system. To date, typical single serve ADCs are relatively low powered at around 600 watts. These unpressurized single serve machines are not currently as popular as pressurized systems.

A high powered, unpressurized (i.e., “drip”) single serve brewed beverage maker as disclosed herein addresses these and/or other issues in the single serve, brewed beverage market. The single serve, unpressurized beverage maker disclosed below has a relatively fast brew cycle while delivering consistent and user-controlled brewed beverage flavor.

### SUMMARY

The present disclosure is directed to a brewed beverage maker, such as a coffeemaker, adapted to quickly and effectively brew a single serving of loose coffee grounds. In one embodiment, the grounds are brewed directly in a scoop that transfers the grounds to the subject drip beverage maker. The coffeemaker and scoop facilitate loading and removing the coffee to or from the coffeemaker. That is, the scoop is operable to gather and transfer loose infusible material to the beverage maker, but the scoop can also be directly inserted into the beverage maker in place of a brew basket. During a brew cycle, the beverage maker passes hot water through the scoop that contains the loose infusible material and the resulting brewed beverage is dispensed into a brewed beverage receptacle. The scoop comprises a floor with a filter, at least one sidewall, and a handle. As noted above, the scoop is operable to transfer loose infusible material directly into the beverage maker without filling a separate brew basket. The handle on the scoop aligns with a slot in the beverage maker to properly align the scoop in place under a showerhead.

The coffeemaker provides a hook to store the scoop on the coffeemaker when not in use. As such, the user does not have to search for the scoop or otherwise store the scoop separately from the beverage maker.

The subject beverage maker is unpressurized in that the hot water is not forcibly pumped and there is no sealed brew basket, brew chamber, cartridge, or the like that is maintained above atmospheric pressure. Instead, a relatively high powered (1000+ watt) heater creates a high flow rate of water to the showerhead. As described further below, the showerhead includes a preferential water distribution port. The showerhead also includes at least one sprinkler port that allows for a lower flow rate than the preferential water distribution port.

The showerhead includes an elastomeric seal that seats on or contacts the top of the scoop to reduce or eliminate vapor loss and the like. The showerhead and corresponding showerhead seal can be biased into position by a spring. However, the hot water is not pressurized and the scoop cannot be pressurized as at least the overflow port creates an opening to atmospheric pressure. In one embodiment, the spring is an over-the-center spring so as to bias the showerhead away from the scoop when a use moves the showerhead up and away from the scoop.

In further detail, the showerhead and scoop are specifically constructed to bypass a portion of the fresh water around the coffee bed. A portion of the fresh water flowing from the showerhead will not enter the coffee bed (or other infusible material) in the scoop. The subject beverage maker produces a high flow rate for an unpressurized coffee maker. The bypass mechanism helps to manage the higher flow rate and to prevent the scoop from flooding during a brew cycle.

In one embodiment, the bypass mechanism comprises a water conduit from the heater to the showerhead that delivers the hot water to the showerhead proximate the preferential water distribution port of the showerhead, which is a relatively large opening in the showerhead. The water flow from the heater is greater than the flow rate through the showerhead preferential water distribution port so the showerhead includes additional showerhead sprinkler ports to distribute the water to the scoop, which is situated below the showerhead.

The bypass mechanism further comprises an overflow port in a sidewall of the scoop that is aligned with and beneath the preferential water distribution port. The overflow port is as an aperture through the sidewall of the scoop and some distance from the floor of the scoop. The overflow port is largely a bypass hole that allows water to drain or be diverted from the scoop without passing through the coffee bed or floor/filter of the scoop.

The showerhead's preferential water distribution port creates a dedicated water stream in the scoop proximate the overflow port. A portion of the dedicated stream will pass through the overflow port thereby exiting the scoop without passing through scoop floor, which is a permanent filter. It is anticipated that some portion of the hot water is almost constantly bypassing the scoop during a brew cycle. A majority of the water in the dedicated stream will enter the infusible material bed found on the floor of the scoop. This majority portion of the water in the dedicated stream, along with any water from the showerhead sprinkler ports, leads to water pooling in and wetting the infusible material. As pooling increases, an overflow or flooding condition eventually occurs wherein the fluid increasingly flows out the overflow port.

An overflow screen is located in or proximate to the overflow port. The overflow screen works to prevent grinds from exiting the scoop through the overflow port. The overflow screen and overflow port are located on the scoop sidewall proximate to the scoop handle. The dedicated water stream serves the purpose of rinsing this overflow screen to reduce clogging.

In one embodiment, if or when the basket begins to flood during a brew cycle so that water level in the scoop reaches the level of the overflow screen, the dedicated water stream will more preferentially exit through the scoop's overflow port. Water in the scoop is constantly draining through the scoop's filtered floor so diverting the dedicated water stream allows the scoop's coffee bed to return to a non-flooded state. Moreover, in at least one embodiment, it is possible for the water/brewed beverage in the scoop to flood to such an extent as to pass over the top of the overflow screen and exit the scoop via the overflow port. This mechanism is provided in the event that the overflow screen becomes clogged. The concept is to prevent the water/brewed beverage and coffee grinds from flooding to the extent that the grinds come into contact with the bottom surface or seal of the showerhead.

A secondary filter is positioned in the beverage maker below the scoop. The secondary filter captures any loose grinds that may be on the exterior of the scoop or that overflow from the scoop. The brewed beverage or bypassed hot water passes through the secondary filter and into a funnel. The funnel directs the brewed beverage or bypassed water into a receptacle such as a coffee mug or travel mug.

In one embodiment, the fluid to be infused by the subject beverage maker is not forcibly pumped but is instead motivated by a thermal pump so that brewing occurs at atmospheric pressure. A mechanical motorized pump or gravity flow system could be used to achieve flow rates similar to the relatively high flow rate of the subject beverage maker.

The thermal pump may be a flow-through type, thermal heater pump that is operable to heat and lift the water in the heater to the showerhead. This type of heater is aligned in a vertical configuration. In use, water from the fresh water reservoir flows into the bottom of the heater. The heater is selectively energized. A difference in the water density occurs between the heater inlet and an outlet located at the top of the heater. Once the water inside the heater reaches 100 C and saturated steam bubbles being to form, the density proximate the outlet is further decreased and hot water begins to flow up an outlet tube. It is thought that the subject heater will be a 1000+ watt heater. In one embodiment, the heater is a 1300 watt heater.

In at least one embodiment, the brewed beverage maker further comprises an L-shaped cup support stand that can be flipped upside down to adjust a cup support height. In a first orientation, the L-shaped cup support stand has a cup support height that is flush with the top of the base of the beverage maker. In a second orientation, tabs on the cup support stand fit into corresponding slots/recesses on the beverage maker to support the cup support stand as an inverted L-shape. The tabs are located proximate the junction of the two legs that form the L-shape. In this second orientation, the cup support stand acts as a shelf to support a cup at distance above the base of the beverage maker. A user can place the cup support in either orientation to adjust the height of the cup support. The adjustable cup support is placed in either orientation to correspond to the type of receptacle to be filled.

In use, a user fills the scoop with an infusible material, such as coffee grounds, by scooping the material with the scoop or otherwise filling the scoop. Instead of filling a separate filter basket and guessing as to the correct quantity or placement of the grounds, the scoop here is directly inserted into the beverage maker eliminating the need to transfer the loose infusible material to another receptacle. The scoop's handle is aligned with a handle-receiving slot on the beverage maker so that the handle seats in the beverage maker in the proper position. The user lowers the showerhead assembly to enclose the handle within the slot. An over-the-center spring may act to bias the showerhead assembly up and down. In this manner, the elastomeric seal can be biased against the top rim of the scoop. Once the scoop is loaded and the showerhead is in position, the user initiates an automatic drip brew cycle.

Overall, the preparation and initiation of a brew cycle is intended as a ‘one-handed’ operation. The likelihood of spilling any coffee grounds is reduced as the user does not need to transfer loose infusible material into a brew basket. The showerhead assembly is biased to both an up/open position and down/closed position so that the user does not need to manually hold the showerhead during the loading of the scoop.

Further features and advantages of the present invention will become apparent to those of skill in the art from the following detailed description of a preferred embodiment taken in conjunction with the accompanying drawings.

### BRIEF DESCRIPTION OF THE FIGURES

The foregoing summary, as well as the following detailed description of a preferred embodiment(s) of the invention, will be better understood when read in conjunction with the appended drawings. For the purpose of illustrating this disclosure, there is shown in the drawings certain embodiments that are presently preferred. It should be understood, however, that the disclosure and following claims are not limited to the precise arrangements and instrumentalities as illustrated. The figures are described as follows:

FIG. 1a is a perspective view of a preferred embodiment of a beverage maker as disclosed herein;

FIG. 1b is a further perspective view thereof;

FIG. 1c is a cross section view thereof;

FIG. 2 is a perspective view of a cup support stand as disclosed herein;

FIG. 3 is a further perspective view of a beverage maker as disclosed herein;

FIG. 4 is a cross-section view of a showerhead, scoop, secondary filter and dispensing funnel as disclosed herein;

FIG. 5 is an additional cross-sectional view thereof;

FIG. 6 is a top view of a showerhead and water conduit as disclosed herein;

FIG. 7 is an additional view thereof;

FIG. 8 is an additional view thereof;

FIG. 9A is a perspective view and diagram of a scoop with an overflow port and overflow filter as disclosed herein;

FIG. 9B is perspective view of another embodiment thereof;

FIG. 10 is a cross-sectional view of one embodiment of a scoop disclosed herein with a diagramed fluid flow therethrough;

FIG. 11 is a view of a showerhead assembly for the subject beverage maker as disclosed herein; and

FIG. 12 is an exploded view of one embodiment of the subject beverage maker as disclosed herein.

### DETAILED DESCRIPTION

The present disclosure is directed to brewed beverage maker and a related scoop. A coffeemaker is described in terms of various embodiments herein. In general, the beverage maker is a high powered (i.e., high flow rate), drip (i.e., unpressurized) beverage maker, such as a coffeemaker, for brewing single-serving sized portions of a brewed beverage. In conjunction with the scoop, there is provided an easy-to-use and novel brewed beverage maker construction. A water by-pass system is employed to manage the higher flow rates while maintaining the strong flavor qualities of the brewed beverage. Additionally, a secondary filter is included. A cup height adjustment mechanism may be provided with the brewed beverage maker for use with beverage receptacles of various sizes or heights. Of course, the present invention is not limited to the above features or following specific embodiments but also includes variations and equivalent structures that would be apparent to one of skill in the art in light of the subject disclosure.

Certain terminology is used in the following description for convenience only and is not limiting. The words “right”, “left”, “lower”, “upper”, “below”, “above”, “front”, “back”, etc. designate directions in the drawing to which reference is made. The words “inwardly” and “outwardly” would refer to directions toward and away from, respectively, a geometric center of the beverage maker or scoop and designated parts therefore. Terminology includes the above-listed words, derivatives thereof and words of similar import.

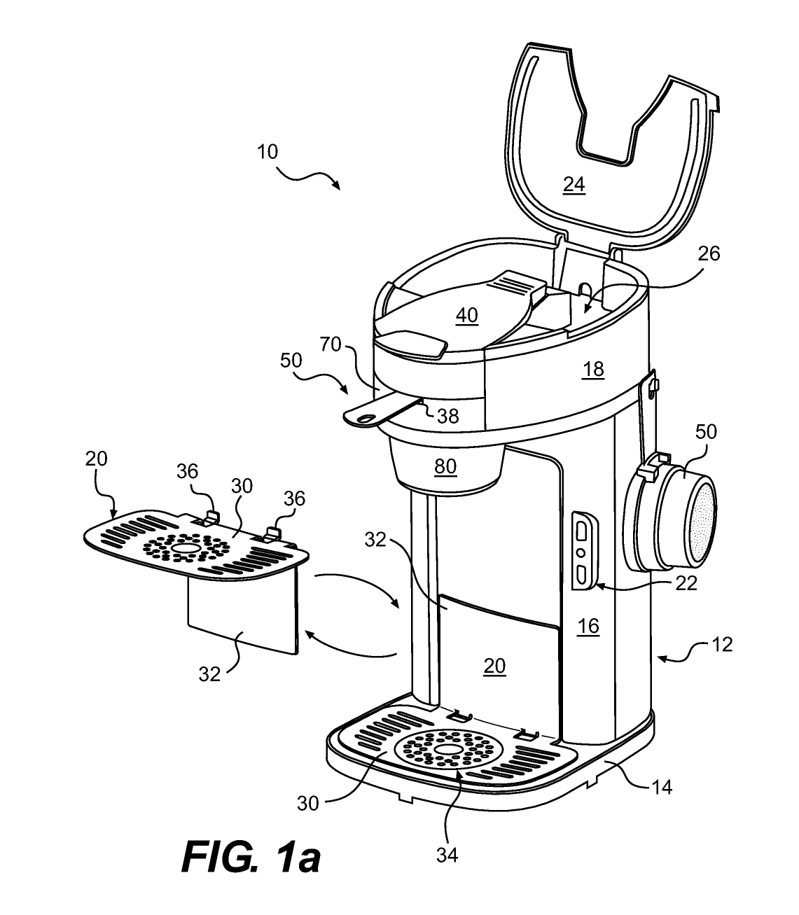

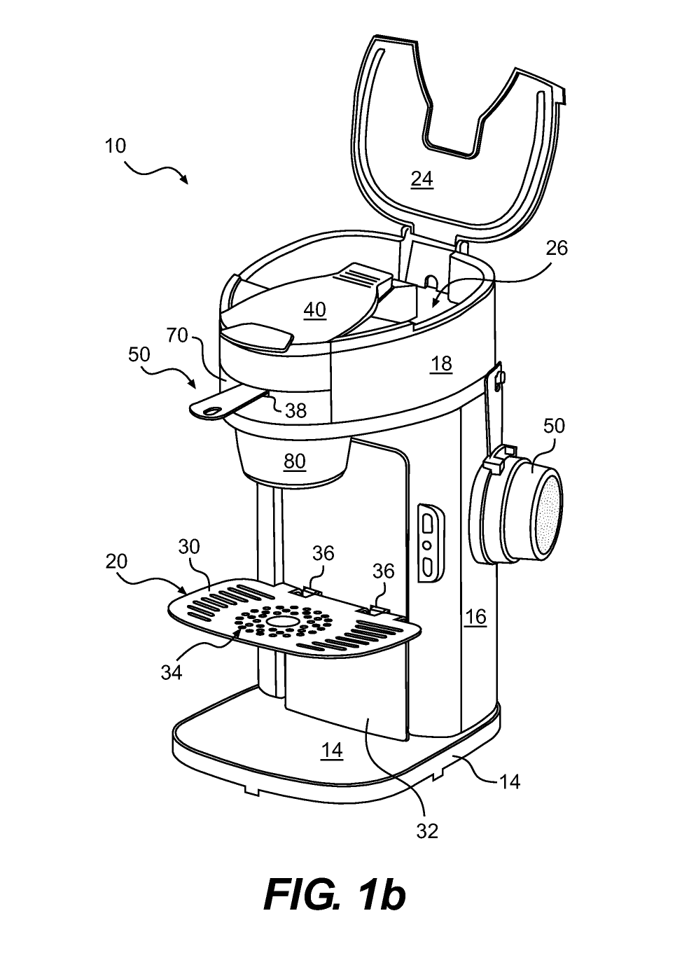

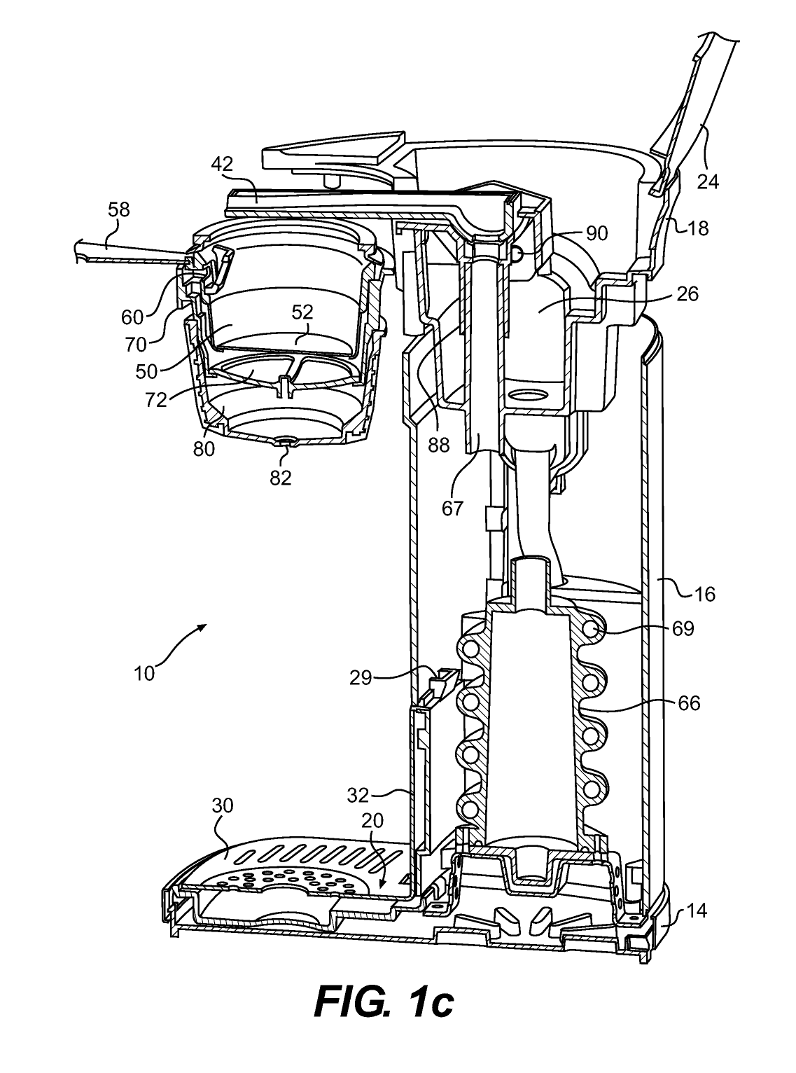

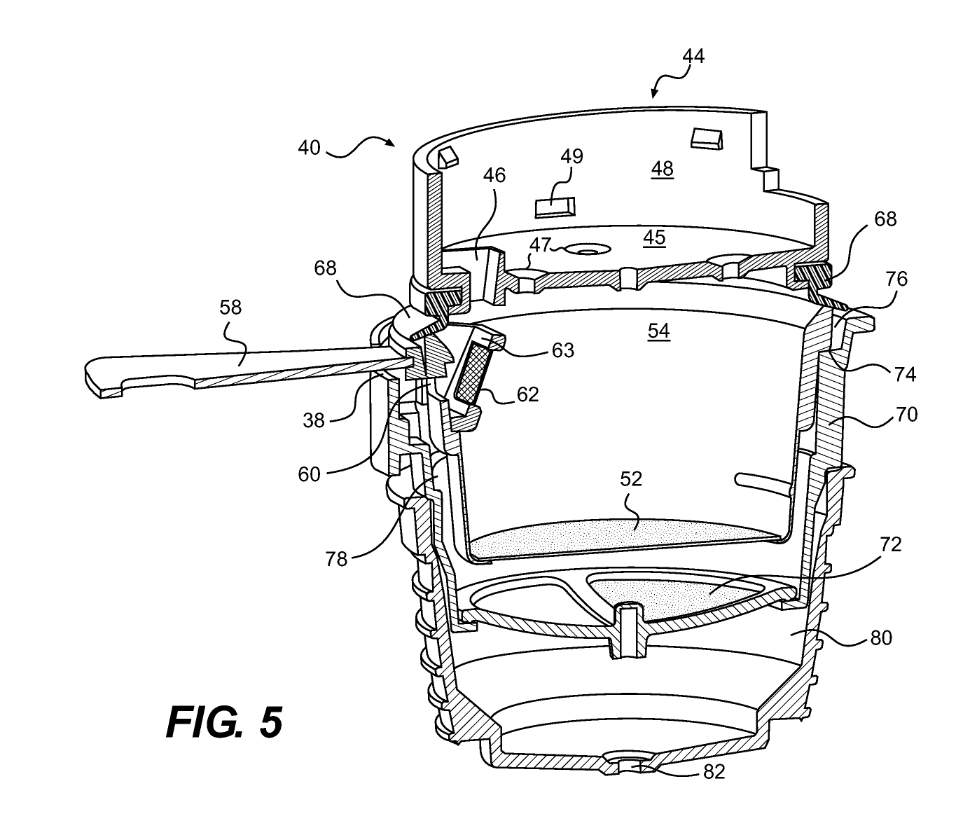

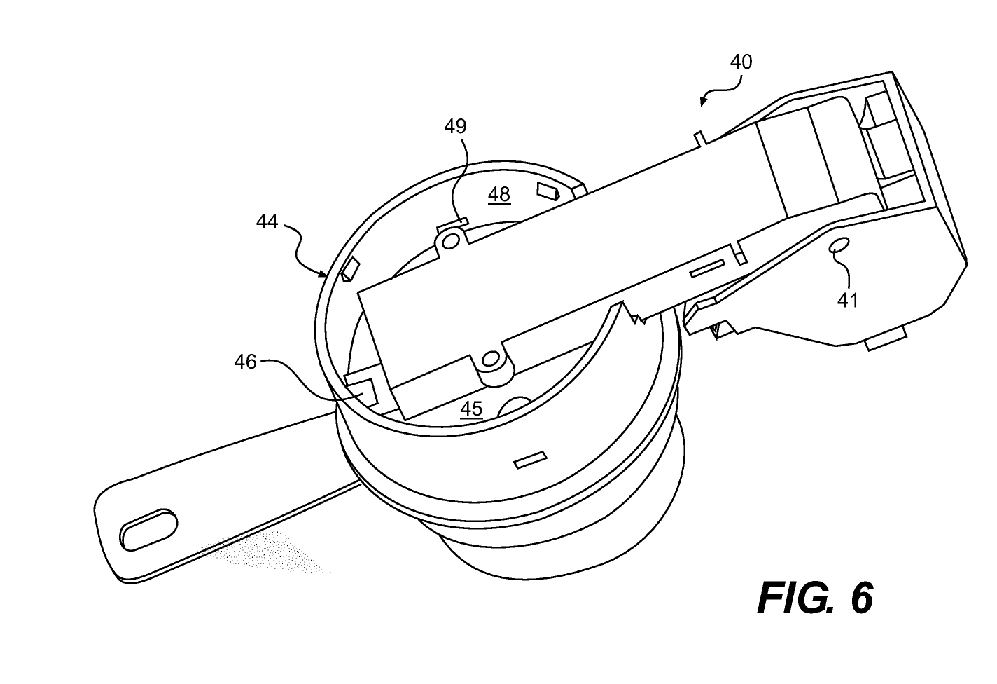

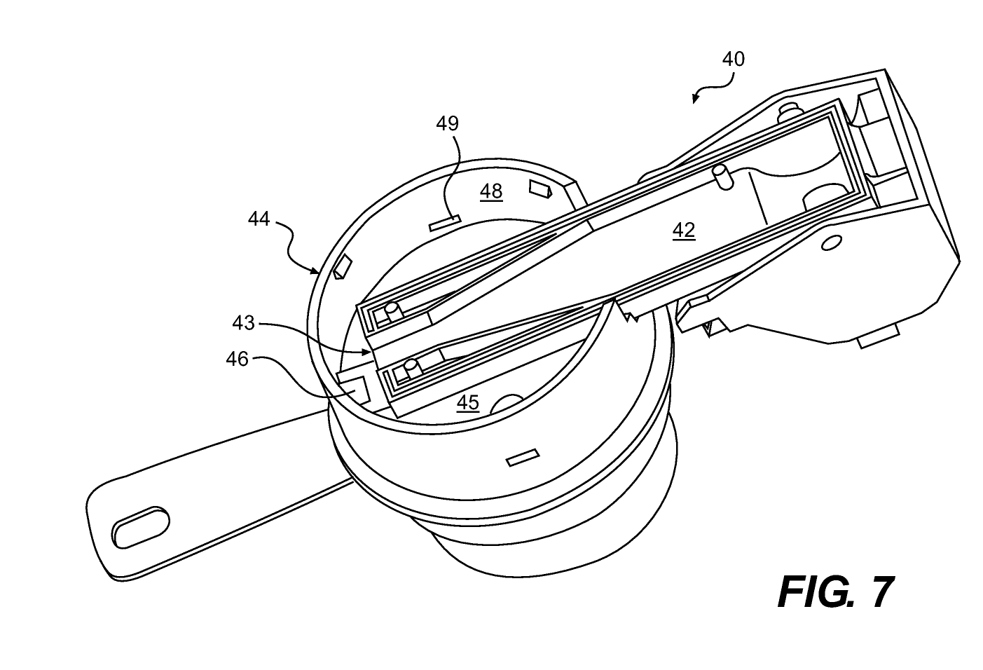

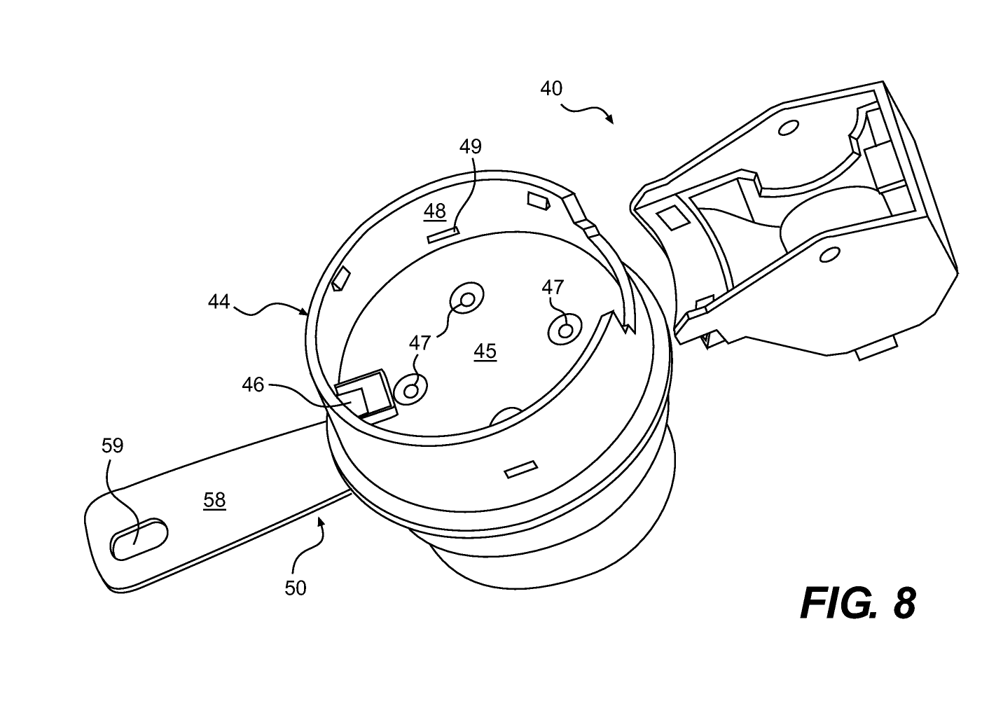

Referring to the drawings in detail, wherein like numerals indicate like elements throughout, there is illustrated in FIGS. 1-11 preferred embodiments of a beverage maker, generally designated 10, for producing a single serving of brewed beverage. “Single serving” in this context will mean a quantity of brewed beverage intended to be consumed by one person, such as the volume of brewed beverage that would fill, or at least partially fill, a coffee mug or brewed beverage travel mug.

Referring to FIGS. 1-3, beverage maker 10 includes a housing 12 with a base 14 resting on a support surface, a stand 16 extending upwardly from base 12, a head 18 supported atop stand 16, and an optional, adjustable cup support 20. Cup support 20 would be L-shaped with a first leg 30 connected to a second leg 32 at a 90 degree angle. First leg 30 of support 20, which may be made of plastic, metal, or other suitable material, is perforated by a plurality of apertures 34 that allow a fluid to pass therethrough.

Base 14 and stand 16 can support cup support 20 in two different orientations. In the first orientation, first leg 30 is flush or proximate with base 14 with second leg 32 extending upwardly and nesting in a front face of stand 16. A receptacle, like a travel mug, could be placed on support 20 so that the receptacle is on base 14 of beverage maker 10 in a position under head 18. During a brew cycle, hot water passes through head 18 and is dispensed into the receptacle positioned on support 20 under head 18.

Support 20 can be moved into a second orientation on beverage maker 10 by turning support 20 upside down from the first orientation. In this second orientation, first leg 30 projects outwardly from stand 16 above base 14 as a raised shelf. Second leg 32 extends downwardly from first leg 30 and nests in the front face of stand 16.

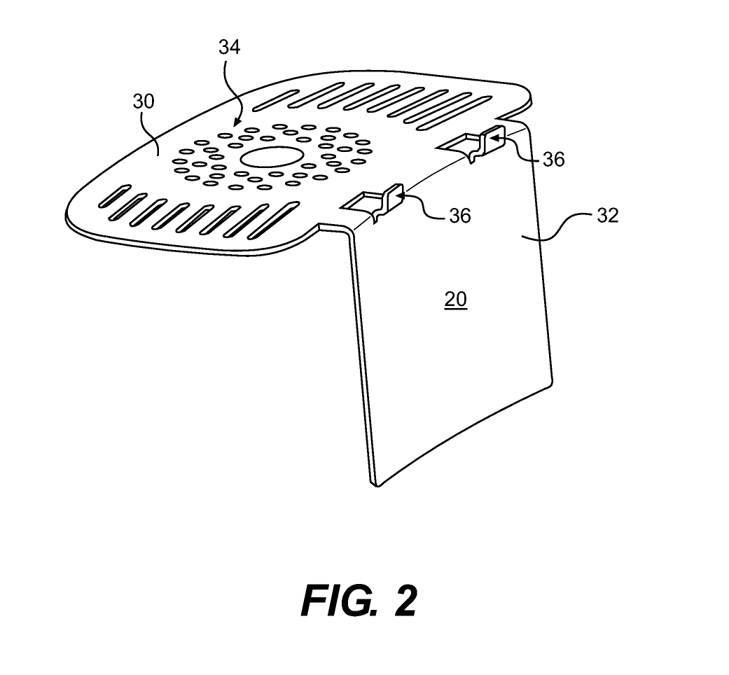

With specific reference to FIGS. 1b, 1c and 2, support 20 is held in position in this second orientation by one or more tabs 36 that extend from support 20 at the junction of first leg 30 and second leg 32. Tab(s) 36 comprise hooks that extend outwardly from support 20. In one embodiment, tabs 36 first extend largely in plane with and away from first leg 30. Tabs 36 then turn 90 degrees so that they are perpendicular to and above (in this second orientation) first leg 30. In the first support orientation, tabs 36 are concealed in base 14. In the second support orientation, whereby the cup support acts as a raised shelf on beverage maker 10, tabs 36 hook into corresponding mating recesses in stand 16.

The second orientation of support 20 is best illustrated in FIG. 1b wherein tabs 36 are inserted upwardly into mating recesses 29 (see also FIG. 1 c) provided by stand 16. Tabs 36 are hooked in mating recesses 29 so that support 20 cannot rotate down and away from stand 16. To remove support 20, a user would tilt second leg 32 away from stand 16 and then retract tabs 36 out of mating recesses 29 by pulling support 20 down and away from stand 16.

Hooking tabs 36 into stand 16 allows support 20 to bear the weight of full beverage receptacle on first leg 30 in a cantilevered fashion. In either orientation, any spilled beverage or splashes would drain through the plurality of apertures 34 into base 14, which would contain the beverage for later cleaning. As illustrated in FIG. 1c, second leg 32 of support 20 is flush with the front face of stand 16. Second leg 32 nests within stand 16.

The adjustable cup support 20 permits a user to place a tall travel mug (not illustrated) under head 18 in the support's first orientation or to place a shorter coffee mug (not illustrated) on support 20 in the support's second orientation. The distance between the coffee mug and head 18, from which the brewed beverage is dispensed, is reduced by placing the cup support in the second orientation. The raised shelf provided by the second orientation of support 20 reduces the distance that the brewed beverage travels from head 18 to the receptacle. Reducing the distance the brewed beverage travels reduces or prevents the brewed beverage from splashing from the receptacle during a brew cycle.

Beverage maker 10 may further include conventional beverage maker controls 22, which can optionally include features such as a timer, on/off buttons, and the like. Housing 12 can also include a lid 24 that would be hingedly connected to housing 12 on head 18. Lid 24 can be selectively opened and closed so as to permit or prevent access to a fresh water reservoir 26 located inside stand 16 under lid 24.

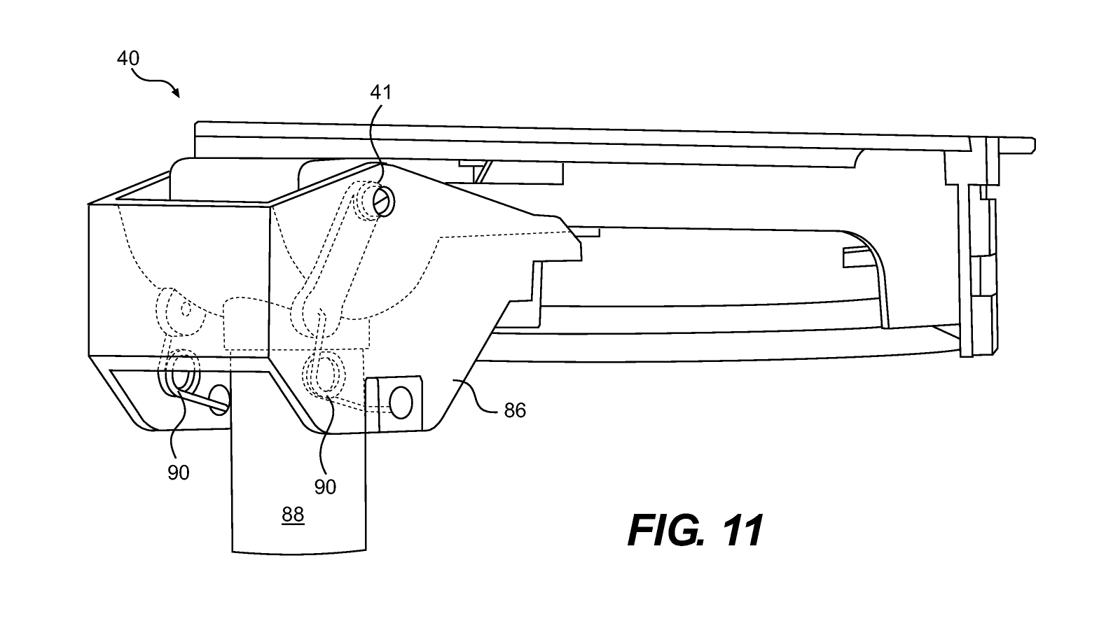

A showerhead assembly 40, as discussed further below, is also hinged to head 18 and is independently moveable relative to lid 24. Showerhead assembly 40 includes a water inlet conduit 42, a showerhead 44, and spring-biased hinge 41 (see, e.g., FIG. 11). Showerhead assembly 40 is placed into a lowered, operational position wherein showerhead 44 is horizontal and parallel to base 14. In the lowered position, the upper surface of showerhead assembly 40 is flush with lid 24 when lid 24 is likewise is in the closed position (not illustrated). Showerhead assembly 40 can then be rotated on hinge 41 up and away from head 18 into a raised, non-operational position whereby a user can better access the space below showerhead 44. A user can independently actuate fresh water reservoir lid 24 relative to the showerhead assembly 40.

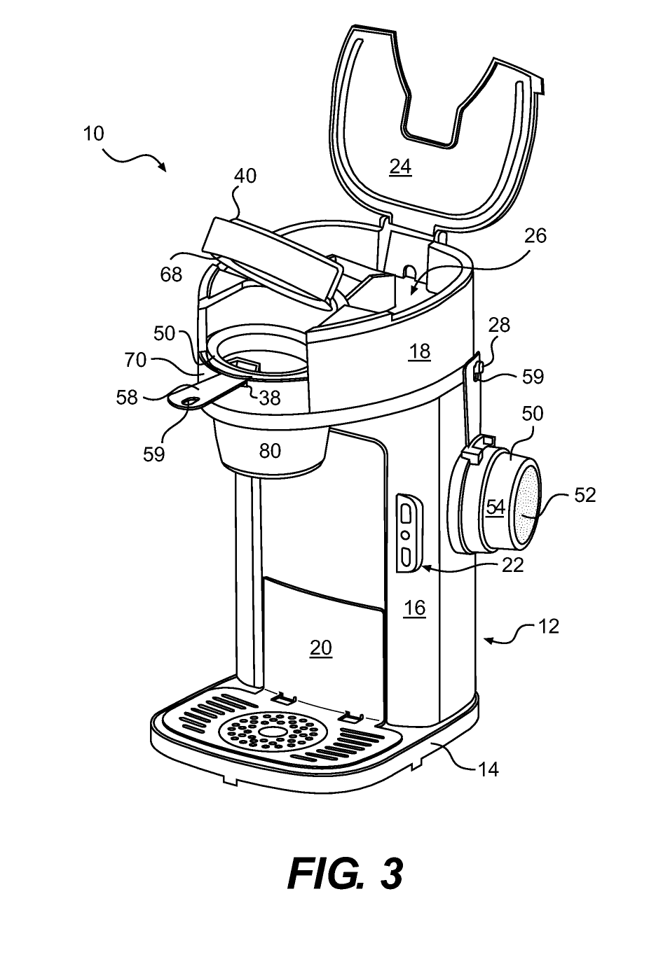

Beverage maker 10 may further comprise one or more scoops 50. In a preferred embodiment, a single scoop 50 is provided. FIGS. 1a, 1b, and 3 include two scoops 50 in order to illustrate both the operational position of scoop 50, whereby it is placed in head 18 under showerhead assembly 40, and the storage position of scoop 50, whereby it is stored on beverage maker 10.

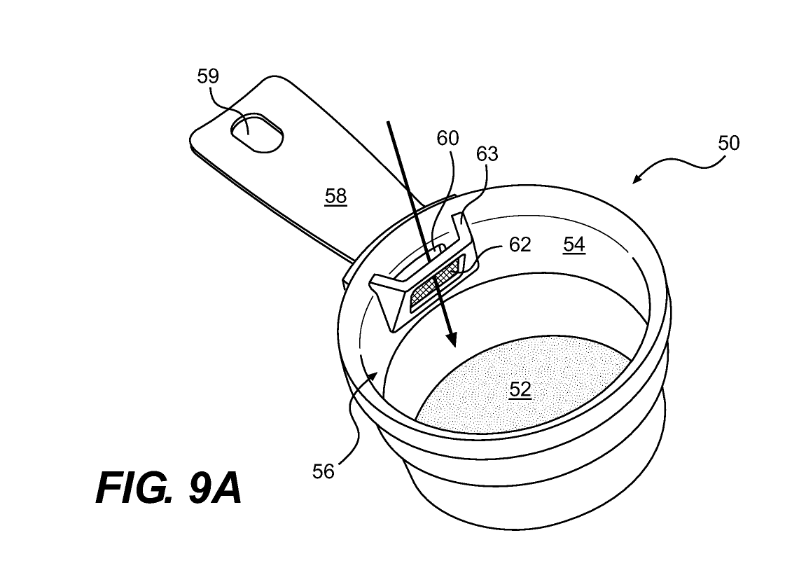

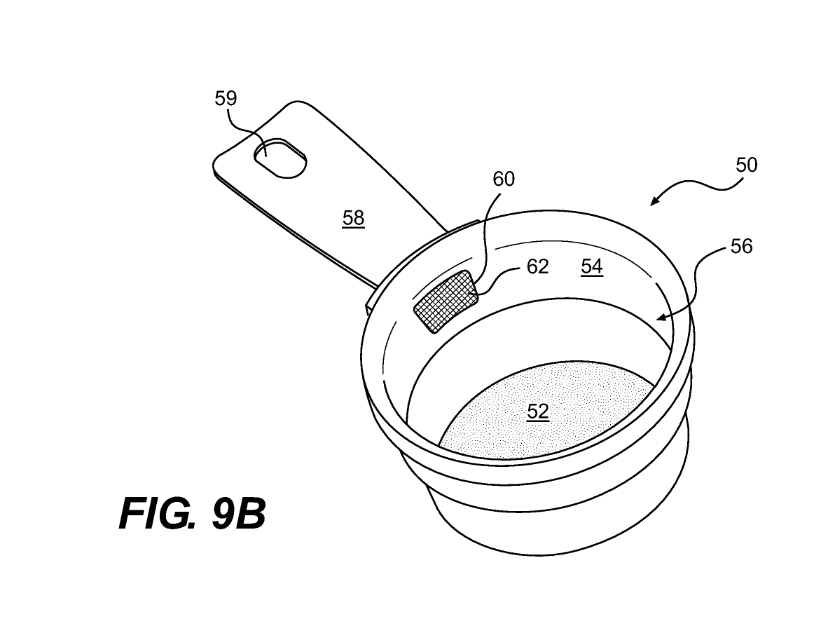

With reference now to FIGS. 9A and 9B, scoop 50 includes a floor 52, at least one sidewall 54, an open top 56, a handle 58, a rising port 60, and an overflow screen 62. Floor 52 comprises, completely or in part, a permanent filter. The floor filter would be such that a loose, infusible material, such as loose coffee grinds, could not pass through floor 52. However, a brewed beverage can drain from scoop 50 via the floor filter.

Sidewall 54 may comprise a continuous, circular wall or other shape. Sidewall 54 extends upwardly from floor 52 and defines open top 56. Handle 58 is attached to and extends outwardly from sidewall 54. Handle 58 is positioned on sidewall 54 proximate overflow port 60. Handle 58 may also include a handle aperture 59.

Overflow port 60 is an opening through sidewall 54 of scoop 50. An overflow screen 62 can be integral with overflow port 60, as illustrated in FIG. 9B. Alternatively, rinsing screen 62 may be supported by a screen structure 63 that supports rinsing screen 62 in a position spaced inwardly from sidewall 54 and proximate to overflow port 60. In this embodiment, a fluid in scoop 50 would pass through screen 62 or over/through screen structure 63 to exit scoop 50 via overflow port 60.

Referring back to FIGS. 1a-1c and 3, scoop 50 is postionable directly into a recess below showerhead assembly 40. As such, scoop 50 can be used to gather and directly transfer loose infusible material, like loose coffee grounds, to the beverage maker 10. A user can scoop up coffee grounds from a container and would then place the scoop, which is still holding the coffee grounds, directly into the beverage maker 10. It is not required that a user transfer loose coffee grinds into a separate brew basket by a spoon or other device or otherwise attempt to pour grounds into a brew basket or brewing chamber. The direct placement of the scoop with the infusible material into beverage maker 10 would eliminate spills that are often associated with preparing a beverage maker for a brew cycle.

Head 18, which is located atop stand 16 above base 14, has a front face and top surface. The top surface is defined by lid 24 and showerhead assembly 40 when both lid 24 and showerhead assembly 40 are in the down/closed positions. The front face is at least partially defined by a brew chamber 70 and the distal face of showerhead assembly 40 when showerhead assembly is in the closed position. Lid 24 and showerhead assembly 40 can both rotate up and away from head 18 into up/open positions (as in FIG. 3). Brew chamber 70 further comprises a slot 38 located on the front face of head 18 below showerhead assembly 40. Slot 38 is an opening from an internal space of beverage maker 10 (i.e., brew chamber 70) to the front face of head 18.

Scoop 50 can be placed in head 18, as described further below, and the showerhead assembly moved to the closed position so that sidewall 54 and floor 52 are enclosed within beverage maker 10. Scoop handle 58 would be positioned so as to extend through slot 38 to the exterior of beverage maker 10 from the enclosed sidewall 54. Scoop handle 58 extends outwardly from beverage maker 10 when scoop 50 is positioned in brew chamber 70. Slot 38 accommodates the structure of scoop 50 but also acts to align scoop 50 in the proper position under showerhead assembly 40, as described further below. In one embodiment, slot 38 would be dimensioned to be just wider than the width dimension of handle 58 where handle 58 passes through housing 12 from the internal recess under showerhead assembly 40 to the exterior of housing 12. Once scoop 50 is seated in beverage maker 10 it cannot rotate side to side as handle 58 is closely bound on each side by slot 38. Scoop 50 is removed from beverage maker 10 by lifting showerhead assembly 40 to the up/open position and lifting scoop 50 up and out of the internal recess and slot 38. Alternatively, it is possible to remove brew chamber 70 with scoop 50 still in position.

In further detail, when placing scoop 50 into beverage maker 10, showerhead assembly 40 is necessarily in the up/open position. Slot 38 appears as a channel along a front edge of the front face of head 18 (i.e., face of brew chamber 70). It is clear to the user that scoop 50 is properly positioned in beverage maker 10 when handle 58 nests in slot 38. The user can then lower showerhead assembly 40 to the down/closed position. The top of slot 38 is closed by showerhead assembly 40 so that scoop 50 is held in slot 38. Were scoop 50 improperly aligned, scoop 50 could not be positioned properly in brew chamber 70. Also, if handle 58 is not properly seated in slot 38, showerhead assembly 40 could not be fully lowered into the operative, closed position as handle 58 would obstruct the movement of showerhead assembly 40.

To prepare for a brew cycle, lid 24 is lifted to the up position and a user pours a volume of water into fresh water reservoir 26. Lid 24 may thereafter be closed. The water passes from the fresh water reservoir to enter a vertically-aligned heater 66 from the bottom. Heater 66 is a flow-through type, thermal heater pump used to heat and lift the water in heater 66 to showerhead 44. This type of heater is aligned in a vertical configuration. Heater 66 may be an aluminum die-cast heater with an embedded or attached steel-sheathed cal-rod resistance wire 69 that converts electrically energy to thermal energy.

In use, water from fresh water reservoir 26 flows into the bottom of heater 66. Resistance wire 69 would be energized. A difference in water density occurs between a heater inlet and heater outlet, which is located at the top of the heater. Once the water inside heater 66 reaches 100 C and saturated steam bubbles being to form, the water density proximate the outlet is further decreased and hot water begins to flow up an outlet tube 67.

The volume of water in heater 66 must reach 100 C before steam bubbles form. Therefore, the flow-through type, thermal heater pump ensures that all the water existing the top of heater 66 is at or very near 100 C, thereby achieving the highest water delivery temperature to showerhead 44 that is achievable in an atmospheric drip brewing system. Outlet tube 67 has a sufficiently large diameter to accommodate a high wattage heater and corresponding high outlet flow rate.

It is envisioned that heater 66 will be a 1000+ watt heater. In one embodiment, the heater is a 1300 watt heater.

A typical ADC heater is a horseshoe-type thermal heater pump that cyclically forms steam bubbles to purge the horseshoe-type heater. In other words, the steam pressure in the heater periodically escapes and fresh water flows to refill the heater. As the inlet flow slows, the water in the heater will reach 100 C and form a steam bubble to purge the heater. The overall water temperature, however, is not 100 C. Therefore, horse-shoe type heaters provide a lower average temperature than the subject flow-through type heater 66.

An internal float switch (not illustrated) would be employed to deactivate heater 66. The float switch would be proximate and just below fresh water reservoir 26 but above or proximate to the top of heater 66. As fresh water reservoir 26 empties, heater 66 is subsequently deactivated to ensure that heater 66 does not boil dry. Fresh water reservoir 26 can be observed by the user to be empty but a volume of water remains in heater 66.

Referring now to FIGS. 1c and 4-8, during a brew cycle hot water moves from heater 66 up a tube 67, through water inlet conduit 42, and into showerhead 44. Showerhead 44 includes a floor 45 and showerhead sidewall 48 to form a reservoir. Water inlet conduit 42 has an outlet 43 proximate showerhead sidewall 48. Outlet 43 is not located centrally within showerhead 44. Positioned proximate to and beneath conduit outlet 43 in floor 45 of showerhead 44 is a preferential water distribution port 46, which is an opening through floor 45 to a space below showerhead 44. Outlet 43 and preferential water distribution port 46 are located near showerhead sidewall 48 so that they, in turn, are fluidly aligned with overflow port 60 of scoop 50. Additional, smaller showerhead sprinkler ports 47 are also provided through floor 45.

In use, water traveling through water inlet conduit 42 from heater 66 will enter showerhead 44 via outlet 43. Outlet 43 and preferential water distribution port 46 are aligned so that some portion of the water immediately exits showerhead 44 by the preferential water distribution port 46. Where the flow rate overwhelms or exceeds the flow capacity provided by preferential water distribution port 46, the water will flood across floor 45 and exit showerhead 44 via one or more showerhead sprinkler ports 47. During a brew cycle, it is estimated that 50% or more of the water entering showerhead 44 will exit via the multiple sprinkler ports with the remaining water exiting via the sole preferential water distribution port 46. One or more optional showerhead bypass ports 49 could be located in showerhead sidewall 48 to prevent water flooding to the level of outlet 43 or conduit 42.

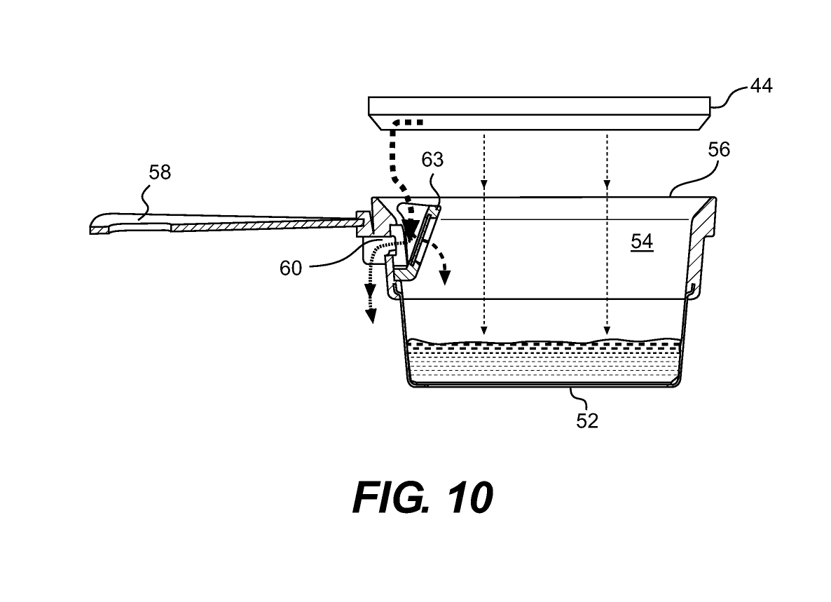

Showerhead 44 is basically a perforated reservoir where water drains to scoop 50 below. However, preferential water distribution port 46 creates a dedicated water stream that has a higher possible flow rate than water exiting showerhead 44 via one of the showerhead sprinkler ports 47. The dedicated water stream is diagramed in FIG. 10, as further disclosed

An elastomeric showerhead seal 68 can be positioned around the lower periphery of showerhead 44. With showerhead assembly 40 in the closed position and scoop 50 seated inside beverage maker 10, seal 68 is in contact with the upper edge of scoop sidewall 54. Seal 68 acts as a vapor barrier during a brew cycle to inhibit steam or water from escaping scoop 50. Scoop 50 is not pressurized during a brew cycle and water is not forcibly pumped into showerhead 44 or scoop 50 under pressure.

Heater 66, showerhead 44, scoop 50, and secondary filter 72 provide a fluid path therethrough from fresh water reservoir 26 to coffee port 82. Water from the fresh water reservoir travels along the fluid path in an unpressurized state (i.e., is not forcibly pumped.). The water moves due to the operation of heater 66, as described elsewhere herein.

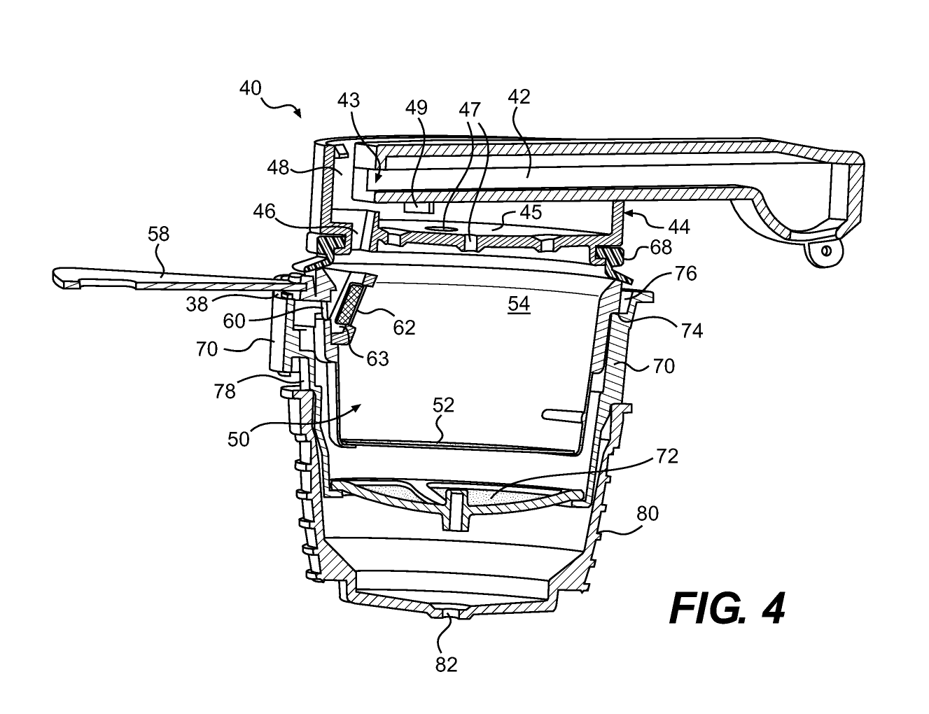

As illustrated in further detail in FIGS. 4, 5 and 10, scoop handle 58 is positioned in slot 38. Handle 58 projects outwardly from the front face of beverage maker 10. Aligning handle 58 with the slot 38 also properly positions overflow port 60 proximate to and beneath preferential distribution port 46. Overflow port 60 is so located and aligned so that a portion of the dedicated water stream from preferential distribution port 46 will bypass the filter of scoop floor 52 via the overflow port (see FIG. 10).

Scoop 50 is supported in brew chamber 70. Brew chamber 70, which can be removably mounted in beverage maker 10, includes an integral or removable secondary filter 72. Secondary filter 72 is positioned in a spaced relationship below scoop 50. Brew chamber 70 further includes a shoulder 74 that supports a lip on scoop 50 proximate to and around the upper periphery of sidewall 54. Between the top of brew chamber 70 and upper edge of sidewall 54 is a channel or moat 76 that retains fluid between brew chamber 70 and scoop 50. Water in moat 76 would flow through moat 76 (i.e. around scoop sidewall 54) until reaching a vertically aligned overflow channel 78. The water passes down through overflow channel 78 to secondary filter 72. Seal 68 directs condensate, steam or water that might escape or overflow scoop 50 during a brew cycle into moat 76.

As diagrammed in FIG. 10, a large portion of water entering scoop 50 will steep in loose infusible grounds located within scoop 50 on floor 52. The infused water will then exit scoop 50 by floor 52, which is a filter, as a brewed beverage. The brewed beverage also passes through secondary filter 72. Secondary filter 72 can catch grinds or smaller particulates that might pass through floor 52.

As noted above, and as further illustrated in FIG. 10, a portion of the dedicated water stream created by preferential distribution port 46 will also bypass scoop 50 by the rising port 60. This bypassed water moves down through overflow channel 78 to secondary filter 72. This bypassed mater might wash grinds from the exterior of scoop 50. As such, secondary filter 72 is useful for preventing those washed grinds from reaching a users mug.

As noted above, overflow port 60 can include an integral rinsing screen 62. Screen 62 prevents grinds from washing from scoop 50. Overflow port 60 serves the purpose of preventing flooding in scoop 50 that may occur due to the relatively high flow rate generated by the high-powered heater used to rapidly produce a single serving portion at acceptably high temperatures. By flooding, it is meant a condition where, generally due to the type or volume of infusible material in the grounds, the inflow into scoop 50 exceeds the outflow through floor 52 to such an extent that the fluid level in scoop 50 threatens to overflow the open top of the scoop. If this were to occur, grinds would contaminate seal 68 and potentially showerhead 44. The contamination would create a burden for the user to clean up.

It is desirable that fluid not flow too rapidly through scoop 50 so that the water will pool and thereby saturate the coffee grounds. As such, an adequate steep or dwell time in the infusible material is desired. Different types and volumes of infusible materials will effect the flow through rate. Overflow port 60 is located above a suggested maximum fill line for the infusible material so as to not prematurely drain fluid that is steeping in the infusible material. Instead, overflow port 60 is located in the upper third of sidewall 54. Fluid reaches the level of overflow port 60 during a flooded scoop condition. The flooding water/brewed beverage, in a first embodiment, passes through overflow screen 62, down overflow channel 78 and through secondary filter 72 and coffee port 82.

In another embodiment, as illustrated in FIG. 10, overflow port 60 is an open, unfiltered aperture. Overflow screen 62 is spaced inwardly from overflow port 60 by a screen support structure 63 that is impervious. The dedicated water stream lands in scoop 50 within the space defined by screen support structure 63 or between overflow port 60 and screen 63. Some minority percentage of the dedicated water stream will splash out of overflow port 60 and thereby bypass the coffee bed on floor 52. A majority portion will pass through overflow screen 62 and enter the coffee bed.

In a flooded condition, fluid in scoop 50 will rise to the level of overflow screen 62 and screen support structure 63. At this level, the fluid must pass through overflow screen 62 to exit scoop 50 by overflow port 60. It is thought that the high fluid level will cause the dedicated water stream to more preferentially exit overflow port 60 which could prevent or reduce any further flooding.

In the event that the infusible material clogs overflow screen 62 or the fluid inflow is so great that flooding continues, the fluid level may continue to rise until it reaches a point that it overflows the screen support structure 63. The fluid would then exit unimpeded through overflow port 60 and any loose infusible material in the fluid would be captured by secondary filter 72. Overall, the screen support structure provides a robust mechanism to prevent contamination of seal 68 and showerhead 44 in the event overflow screen 62 is blocked by infusible material. Any loose grounds that escape scoop 50 are captured by secondary filter 72 to protect the integrity of the brewed beverage dispensed to the user. Brew chamber 70 or secondary filter 72 could then be removed, following the brew cycle, to facilitate cleaning of beverage maker 10.

Whether overflow screen 42 is integral with overflow port 60 or spaced inwardly into scoop 50, the relatively high flow rate of the dedicated water stream, relative to the flow rate through one of the sprinkler ports, acts to clean or rinse overflow screen 42. For example, where overflow screen 42 is integral with overflow port 60, the overflow port can be rendered ineffective if overflow screen 62 is clogged. However, the dedicated water stream contacts overflow screen 62 to create a turbulent condition that should work to reduce clogging. Similarly, in the embodiment where the dedicated water stream passes through overflow screen 62 prior to entering the coffee bed (as diagramed by FIG. 10), the dedicated water stream acts to keep coffee grinds or the like from clogging overflow screen 62.

Brew chamber 70 sits in a funnel 80 that is supported by head 18 and removably positioned thereon. Funnel 80 is at least partially conically shaped. A coffee port 82 is located at the lowest point of funnel 80. Water or the brewed beverage passing through secondary filter 72 is thereby directed to coffee port 82. The brewed beverage exits coffee port 82 and is captured by a user's mug placed on support 20 or base 14.

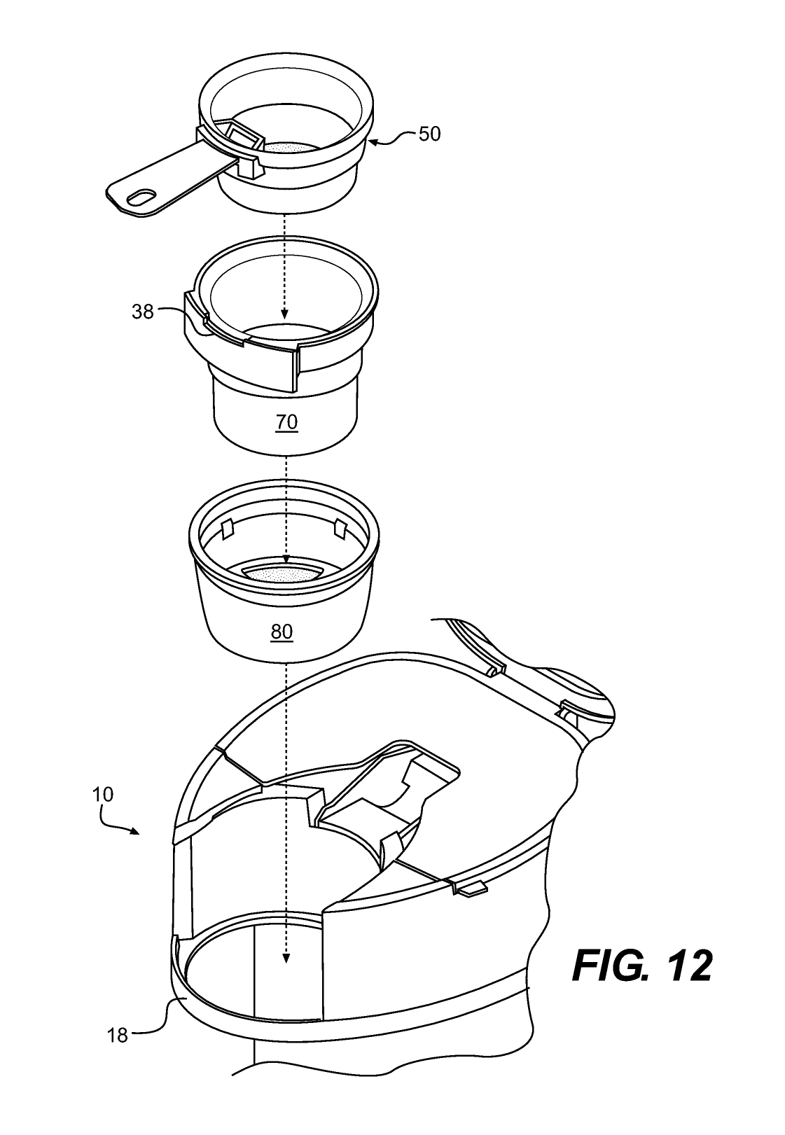

With reference now to FIG. 12, there is illustrated an exploded view of a preferred embodiment where brew chamber 70 and funnel 80 are selectively removed from head 18 of beverage maker 10. Funnel 80 sits is suspended in a support with brew chamber 70 nesting in funnel 80. Scoop 50 then nests in brew chamber 70 with handle 58 in slot 38.

In FIG. 12, showerhead assembly 40 is deleted to illustrate the exploded view. FIG. 11 further illustrates showerhead assembly 40 with a spring biased hinge 41. A bracket 86 is stationary and permanently affixed to beverage maker 10. An inlet tube 88 connects tube 67 from heater 66 to inlet conduit 42 so that inlet conduit 42 is fluidly connected to heater 66.

Hinge 41 can be provided with two wire-form torsion springs 90. Springs 90 will not deflect hinge 41 when showerhead assembly 40 is positioned about halfway between the open and closed positions. Otherwise, springs 90 provide a deflection force to hinge 41. Where showerhead assembly 40 is moved to the open position, springs 90 will bias showerhead assembly 40 open once showerhead assembly moves past the equilibrium mid-way point between the open and closed positions. Springs 90 provide a sufficient bias force to hold showerhead assembly 40.

A user would then close showerhead assembly 40 by moving showerhead assembly 40 down past the equilibrium midpoint between the open and closed positions. Springs 90 would bias showerhead assembly 40 down. With scoop 50 installed in beverage maker 10, springs 90 would provide a bias force on elastomeric seal 68 that is positioned between the upper edge of sidewall 54 and showerhead 44. Springs 90 operate as over-center springs to provide a bias force to either the open, up position or closed, down position.

As briefly noted above, beverage maker housing 12 may further comprise a hook 28 that projects outwardly from any position of housing 12. Hook 28 would preferably be located on the stand 16 or head 18 portions of the housing at a distance from the base greater than the length of scoop 50 as measured from the distal end of handle 58 to the portion of scoop sidewall 54 opposite the distal end of handle 58.

Scoop 50 hangs or is stored on beverage maker 10 by inserting handle 58 over hook 28 via handle aperture 59. Basically, hook 28 serves as means to store scoop 50 on beverage maker 10. By this mechanism, a user does not have to search for scoop 50 or keep it in a drawer or cabinet where it otherwise might be misplaced or take up storage space.

Secondary filter 72 is the “catch-all” to keep coffee grounds (or the like) out of the users' mug. Secondary filter 72 would allow for multiple brew cycles without needing to be cleaned, as the amount of loose ground coffee from each brew cycle progressing to this filter is expected to be minimal.

The subject beverage maker produces a strong single serve portion of brewed beverage much more quickly than conventional, drip beverage makers. Operation of the beverage maker is simplified by eliminating a separate brew basket. Once the fresh water reservoir is filled, a user simply lifts the showerhead assembly, inserts the scoop with the loose infusible material, closes the showerhead assembly and initiates an automatic brew cycle. Each step can be completed with the same hand to provide “one-handed” operation of the beverage maker

While the invention has been described with reference to specific embodiments thereof, it will be understood that numerous variations, modifications and additional embodiments are possible, and all such variations, modifications, and embodiments are to be regarded as being within the spirit and scope of the invention.

What is claimed is:

1. A brewed beverage maker comprising:
a stand including a fresh water reservoir;
a showerhead assembly comprising an inlet conduit and showerhead, the showerhead including a plurality of sprinkler ports;
a scoop comprising a floor, a sidewall, and a handle extending from the sidewall, the scoop floor comprising a filter; and
a recess to selectively receive the scoop within the beverage maker below the showerhead, the scoop sidewall and floor being enclosed in the beverage maker, the scoop handle extending outwardly from the beverage maker.

2. The beverage maker of claim 1, further comprising a secondary filter positioned in the beverage maker below the scoop.

3. The beverage maker of claim 2, further comprising a funnel positioned in the beverage maker below the secondary filter, the funnel comprising a coffee outlet port.

4. The beverage maker of claim 1, the scoop further comprising a overflow port located in the sidewall and an overflow screen.

5. The beverage maker of claim 4, wherein the overflow screen is positioned inwardly from the sidewall and proximate to the overflow port.

6. The beverage maker of claim 5, wherein a screen support structure holds the overflow screen proximate to the overflow port.

7. The beverage maker of claim 1, wherein the showerhead further comprises a preferential water distribution port.

8. The beverage maker of claim 4, wherein the showerhead further comprises a preferential water distribution port, the preferential water distribution port providing a higher possible flow rate therethrough relative to the possible flow rate through one of the sprinkler ports in the plurality of sprinkler ports.

9. The beverage maker of claim 2, further comprising a heater, the heater, showerhead, scoop, and secondary filter providing a fluid path therethrough and water from the fresh water reservoir traveling along the fluid path in an unpressurized state.

10. The beverage maker of claim 1, the beverage maker further comprising a hook, the scoop handle further comprising an aperture, and wherein the scoop hangs from the hook in a storage position.

11. The beverage maker of claim 1, the showerhead further including an elastomeric seal that contacts the scoop sidewall when the showerhead assembly is rotated to a closed position.

12. The beverage maker of claim 11, wherein a spring biases the showerhead seal into position against the scoop.

13. A brewed beverage maker comprising:
a stand including a fresh water reservoir;
a showerhead assembly comprising an inlet conduit and showerhead, the showerhead including a plurality of sprinkler ports;
a scoop comprising a floor, a sidewall, and a handle extending from the sidewall, the scoop floor comprising a filter;
a recess to selectively receive the scoop within the beverage maker below the showerhead;
a secondary filter positioned in the beverage maker below the scoop;
a heater; and
wherein the heater, showerhead, scoop, and secondary filter provide a fluid path therethrough and water from the fresh water reservoir moves along the fluid path in an unpressurized state.

14. The beverage maker of claim 13, the showerhead assembly being rotatable and the scoop sidewall and floor being enclosed in the beverage maker when the showerhead assembly is rotated to a closed position, the scoop handle extending outwardly from the beverage maker.

15. The beverage maker of claim 13, further comprising a funnel positioned in the beverage maker below the secondary filter, the funnel comprising a coffee outlet port.

16. The beverage maker of claim 13, the scoop further comprising a overflow port located in the sidewall and an overflow screen.

17. The beverage maker of claim 13, wherein the showerhead further comprises a preferential water distribution port, the preferential water distribution port providing a higher possible flow rate therethrough relative to the possible flow rate through one of the sprinkler ports in the plurality of sprinkler ports.

18. The beverage maker of claim 13, the beverage maker further comprising a hook, the scoop handle further comprising an aperture, and wherein the scoop hangs from the hook in a storage position.

19. The beverage maker of claim 14, the showerhead further including an elastomeric seal that contacts the scoop sidewall when the showerhead assembly is rotated to a closed position.

20. A method of operating a beverage maker, the method comprising:
filling a scoop with loose infusible material;
inserting the scoop directly into the beverage maker;
aligning a handle on the scoop with a handle-receiving slot on the beverage maker;
seating the handle in the handle-receiving slot;
rotating a showerhead assembly to a closed position so as to enclose the handle within the slot; and
initiating an automatic drip brew cycle.
